(19) United States
(12) Patent Application Publication
(10) Pub. No.: US 2015/0254729 A1
(43) Pub. Date: Sep. 10, 2015

(54) Cost-Per-Display-Time

(71) Applicant: Roshan Fernandes, Mumbai (IN)

(72) Inventor: Roshan Fernandes, Mumbai (IN)

(73) Assignee: Google Inc., Mountain View, CA (US)

(21) Appl. No.: 12/974,827

(22) Filed: Dec. 21, 2010

(51) Int. Cl. G06Q 30/02; G06F 17/30

(52) U.S. Cl. CPC G06Q 30/0272; G06F 17/3053; G06F 17/30864; G06Q 30/0273

(57) ABSTRACT

Methods, systems, and apparatus, including computer programs encoded on a computer storage medium, for providing advertisements. A method may include receiving, from a client device, a query from a webpage presented on the client device, and identifying two or more advertisements responsive to the query, each advertisement associated with one or more keywords, and a cost-per-display-time selected by a respective advertiser associated with the advertisement. The method can further include ranking the two or more advertisements based on at least the cost-per-display-time associated with the respective advertisement, and providing one or more of the ranked advertisements to the client device to be presented on the webpage.

### BACKGROUND

This application is related to U.S. patent application Ser. No. ______ [Attorney Docket Number 2525.3970000] entitled “COST-PER-DISPLAY-TIME PUBLISHER,” filed ______, and to U.S. patent application Ser. No. ______ [Attorney Docket Number 2525.3980000] entitled “COST-PER-DISPLAY-TIME PAYMENT,” filed ______. The contents of both applications are incorporated herein in their entirety by reference.

### BACKGROUND

The Internet provides access to a wide range of resources. For example, web pages for particular subjects are accessible over the Internet. Access to these resources presents opportunities for advertisements to be provided with the resources. A web page can, for example, include advertisement slots in which advertisements can be presented. These advertisements slots can be defined for presentation with a web page, for example, in a pop-up window. The advertisements slots can also be defined in the web page.

Many different pricing schemas can be used when charging advertisers for display of advertisements. One method is by charging per impression of the advertisement, therefore charging the advertiser each time the advertisement is displayed. This method will display an advertisement without a predetermined time period and the advertisement is displayed as long as the browser window in which the advertisement is displayed remains open.

### BRIEF SUMMARY

The embodiments described below include systems and methods for charging for advertisements. According to an embodiment, a method may include receiving, from a client device, a query from a webpage presented on the client device, and identifying two or more advertisements responsive to the query, each advertisement associated with one or more keywords, and a cost-per-display-time selected by a respective advertiser associated with the advertisement. The method can further include ranking the two or more advertisements based on at least the cost-per-display-time associated with the respective advertisement, and providing one or more of the ranked advertisements to the client device to be presented on the webpage.

According to another embodiment, a system may include an advertisement module, implemented on a computing device, configured to receive, from a client device, a query from a webpage presented on the client device and to identify two or more advertisements responsive to the query, each advertisement associated with one or more keywords, and a cost-per-display-time selected by a respective advertiser associated with the advertisement. The advertisement module can be further configured to rank the two or more advertisements based on at least the cost-per-display-time associated with the respective advertisement, and provide one or more of the ranked advertisements to the client device to be presented on the webpage.

According to another embodiment, a computer storage medium encoded with a computer program is provided. The program comprising instructions that when executed by one or more processors cause the one or more processors to perform operations comprising receiving, from a client device, a query from a webpage presented on the client device, and identifying two or more advertisements responsive to the query, each advertisement associated with one or more keywords, and a cost-per-display-time selected by a respective advertiser associated with the advertisement. The operations can further comprise ranking the two or more advertisements based on at least the cost-per-display-time associated with the respective advertisement, and providing one or more of the ranked advertisements to the client device to be presented on the webpage.

Further embodiments, features, and advantages, as well as the structure and operation of the various embodiments are described in detail below with reference to accompanying drawings.

### BRIEF DESCRIPTION OF THE DRAWINGS/FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1A is an example of a cost-per-display-time model.

FIG. 1B is another example of a cost-per-display-time model.

FIG. 1C is another example of a cost-per-display-time model.

FIG. 2 is a block diagram of an example environment in which an advertisement system manages advertising services.

FIG. 3 is a flowchart illustrating a method for providing advertisements associated with a cost-per-display-time, according to an embodiment.

FIG. 4 is a flowchart illustrating a method for charging advertisers for advertisements associated with a cost-per-display-time, according to an embodiment.

FIG. 5 is a flowchart illustrating a method for charging advertisers for advertisements associated with a cost-per-display-time, according to an embodiment.

FIG. 6 is a flowchart illustrating a method for providing advertisements associated with a cost-per-display-time, according to an embodiment.

FIG. 7 is a system diagram that can be used to implement embodiments described herein.

### DETAILED DESCRIPTION OF THE INVENTION

Embodiments are described herein with reference to illustrations for particular applications. It should be understood that the invention is not limited to the embodiments. Those skilled in the art with access to the teachings provided herein will recognize additional modifications, applications, and embodiments within the scope thereof and additional fields in which the embodiments would be of significant utility.

Advertisers can bid on keywords for an advertisement using various pricing models. In some cases, an advertiser can bid using a cost-per-display-time (CPDT) model where the advertiser indicates an amount he/she will pay for presentation of the advertisement in terms of an amount of time the advertisement is displayed. For example, an amount paid per second, per minute, per five minutes, or per hour. When the advertisement is found to be responsive to a query either from a search engine webpage or from a publisher's webpage, the advertisement is provided to be presented on the webpage.

In one embodiment, when the advertisement that is associated with the CPDT is provided to be presented on a search engine results webpage or a third-party publisher's webpage, the amount of time the advertisement is presented is tracked and the advertiser associated with the advertisement is charged an amount as a function of the CPDT and the amount of time.

In another embodiment, a publisher can indicate to receive advertisements that are associated with a CPDT, and can even indicate a minimum CPDT for each advertisement. Advertisements that are responsive to a webpage of the publisher are identified and provided to be presented on the webpage. The amount of time the advertisement is displayed is tracked and an advertiser associated with the advertisement is charged an amount as a function of the CPDT and the amount of time.

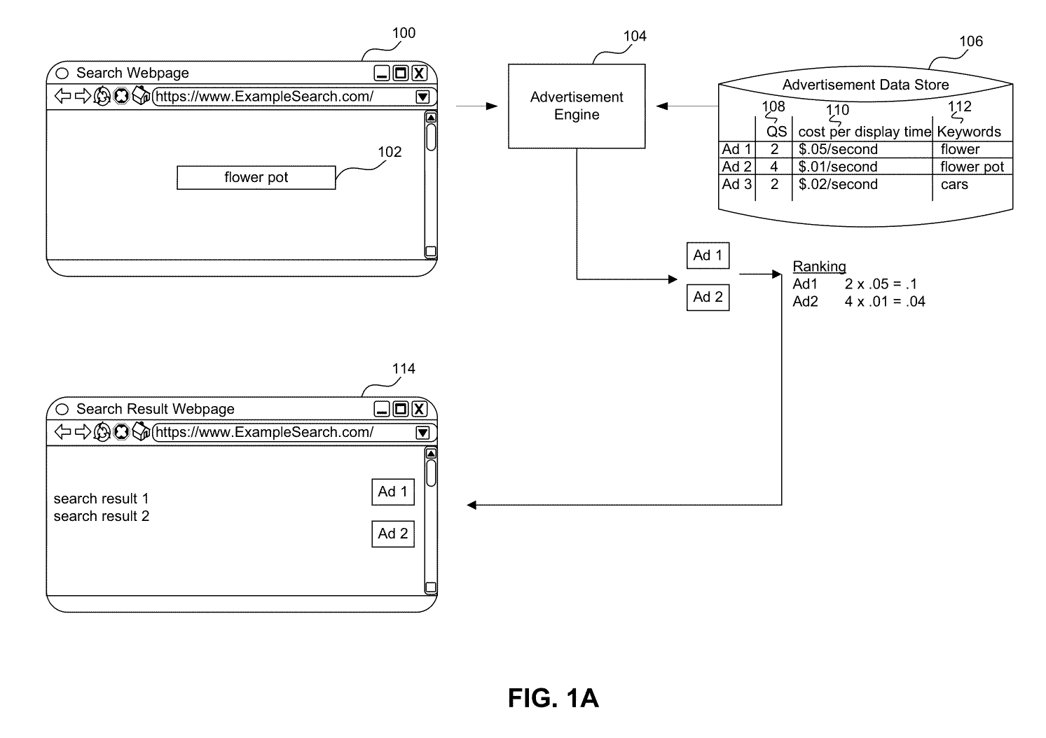

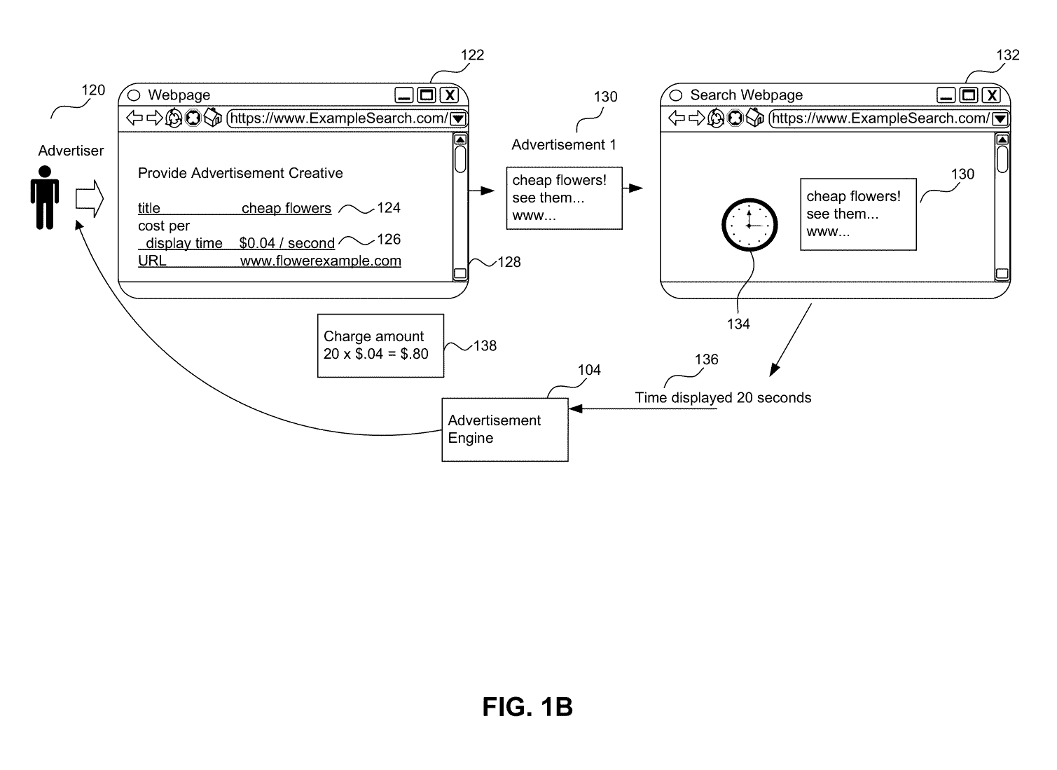

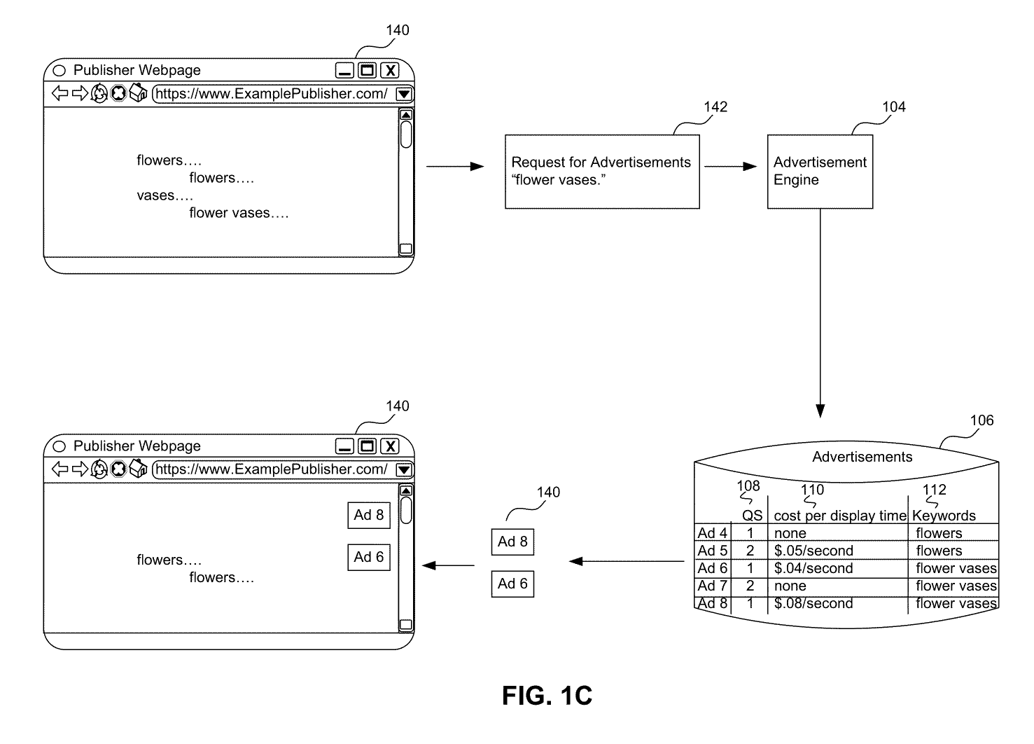

FIG. 1A is an example of a cost-per-display-time (CPDT) pricing model. In the example of FIG. 1A, a user submits a search query 102 using a search webpage 100. In this example, the search query is “flower pot.” An advertisement engine 104 receives the search query 102 to identify relevant advertisements to be provided in response to the search query 102. In some cases, the query can be received from a publisher's webpage and may not include a search query but rather a query that includes words from the content of the publisher's webpage. For example, if the webpage is related to soccer, the query used can be “goal.”

An advertisement data store 106 stores advertisements received from various advertisers. Advertisers may have submitted the advertisements stored in advertisement data store 106 at a previous time. Each advertisement in the Advertisement data store 106 is associated with a quality score 108, a CPDT 110, and keywords 112. The quality score 108 is a score that is associated with the advertisement by the advertisement engine 104 based on a quality of an advertisement. For example, the quality score 108 can indicate how well an advertisement performs based on a click-through rate associated with the advertisement, as will be described below. The CPDT 110 is an amount an advertiser associated with the advertisement has bid for the keywords 112 for the advertisement. The CPDT 110 is the amount the advertiser will pay per specified time period for display of the advertisement. The time period can be set by the advertisement engine 104, by the advertiser, or the publisher. For example, the time period can be per second, per minute, or per hour.

In this example, Ad1 is associated with a quality score of “2,” a CPDT of $0.05 per second for the keyword “flower.” Therefore, the advertiser has indicated that they will pay $0.05 per second for display of Ad1. Ad2 is associated with a quality score of “4,” a CPDT of $0.01 per second for the keywords “flower pot.” Ad3 is associated with a quality score of “2,” and a CPDT of $0.02 per second for the keyword “cars.”

When the webpage 100 receives the search query 102 of “flower pot,” the advertisement engine 104 analyzes the advertisements in the advertisement data store 106 to determine which of the advertisements to provide in response to the request. The advertisement engine 104 will select any advertisement that includes a keyword that is similar to the search query 102 or ones that match the search query 102. In this example, Ad1 is associated with the keyword “flower” which is similar to “flower pot” and Ad2 is associated with the keywords “flower pot” which match the search query 102.

The advertisements identified can be ranked according to one or more ranking metrics. In this example, Ad1 and Ad2 are selected as the relevant advertisements and can be ranked according to a score calculated that is a function of CPDT and the quality score of the respective advertisement. The scores can be calculated as follows:

Ad1=2×$0.05=0.1

Ad2=4×$0.01=0.04

Therefore the advertisements can be ranked in decreasing scores with Ad1 first and Ad2 second, and they can be provided to be displayed on the search result webpage 114 which displays search results that are responsive to the query 102.

FIG. 1B is another example of a CPDT pricing model. In this example, an advertiser 120 provides an advertisement to an advertisement engine 104 using a webpage 122. The advertiser 120 can create a creative for the advertisement 130 and the creative can include various aspects of the advertisement. In this example, the creative includes a title 124, a CPDT 126 and a URL 128. The title 124 provided by the advertiser 120 is “cheap flowers.” The CPDT is $0.04 per second, which is the amount the advertiser 120 will pay for the per second each time the advertisement is presented on a webpage. In some cases, the advertiser 120 can indicate if they want to pay a per second rate, a per minute rate, a per hour rate or any fraction thereof. In other cases, the advertisement engine 104 determines the rate. The advertisement 130 is created from the information provided by the advertiser 120.

When the advertisement 130 is presented on a webpage, for example a search webpage 132, a timer 134 starts to determine the length of time the advertisement 130 is presented. In some cases, the timer can be a plug-in or JavaScript code that is embedded into the webpage 132 and can provide an indication of the display time 136, in this example, 20 seconds, to the advertisement engine 104. The advertiser 120 can be charged as a function of the CPDT and the time presented. In this example, the advertiser 120 is charged an amount 138 of $0.80 because the advertisement was display for 20 seconds and the cost-per-display-time was $0.04 per second.

FIG. 1C is another example of a CPDT pricing model. In the example of FIG. 1C, a publisher of a webpage 140 has indicated to receive advertisement to be displayed along with the content of the webpage 140. The request 142 can include keywords which are displayed on the webpage 140. In this example, the request 142 include the keywords “flower vases” because the content of the webpage 140 is related to “flower vases.” The keywords in the request can be automatically detected by the advertisement engine 104. The publisher of the webpage 140 can also indicate what pricing model the advertisement received should follow. For example, the publisher can indicate to receive advertisement associated with a classic cost-per-click (CPC) model. The publisher can alternatively indicate that the advertisement follow a CPDT model. In some cases, the publisher 140 does not determine what pricing model the advertisement follow, instead the most relevant advertisements are selected, regardless of the pricing model. In this example, the publisher of the webpage 140 has indicated to receive only advertisement associated with a CPDT.

The advertisement engine 104 receives the request 142 and uses the request 142 to identify relevant advertisement from the advertisement data store 106. The advertisements in the advertisement data store 106 are each associated with a quality score 108, a CPDT 110, and keywords 112. The advertisement engine 104 can first identify the relevant advertisements using the keywords “flower vases.” In this example, Ad6, Ad7, and Ad8 are all associated with the keywords “flower vases” and the advertisement engine 104 has identified these advertisements as responsive to the request 142. Ad7, however, is not associated with a CPDT and is therefore not selected as an eligible advertisement because the publisher of the webpage 140 has indicated to only receive advertisements associated with a CPDT.

Depending on the number of slots available on the webpage 140, the advertisement engine 104 can return that many advertisements to be presented on the webpage 140. In this example since there are two slots available, the advertisement engine 104 will return both advertisements Ad8 and Ad6, since both are associated with the keywords “flower vases” and a CPDT. The advertisements Ad8 and Ad6 can be ranked based on the CPDT indicated and then provided to be displayed on the webpage 140 as shown. In some cases, the ranking could have also taken into account the quality score 108 associated with each advertisement.

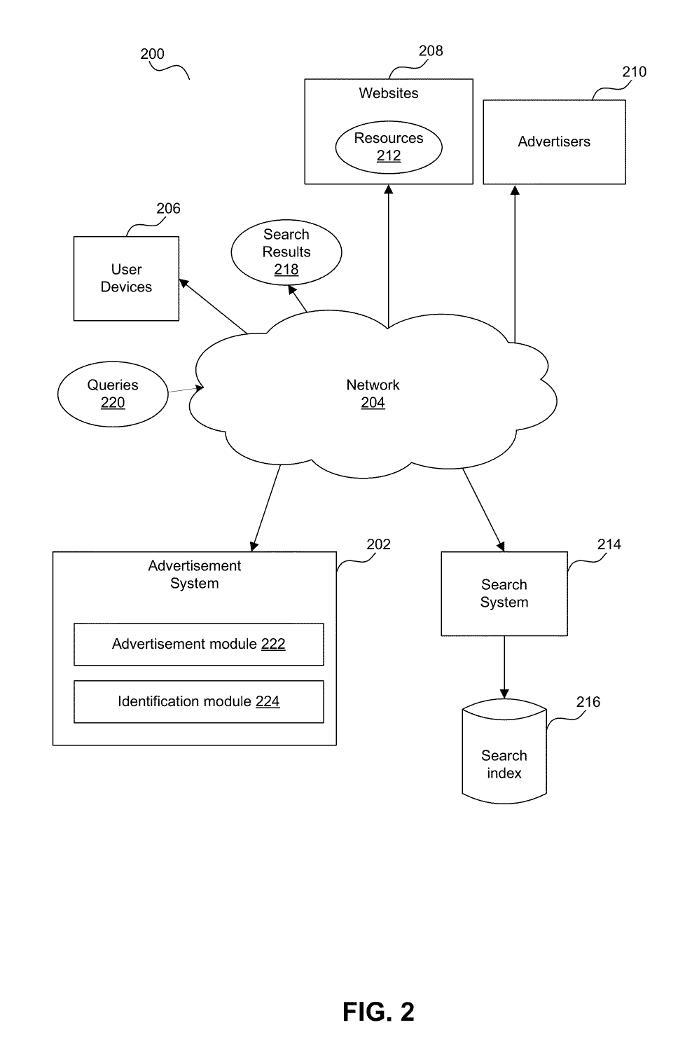

FIG. 2 is a block diagram of an example environment 200 in which an advertisement system 202 manages advertising services. The example environment 200 includes one or more networks 204, such as a local area network (LAN), a wide area network (WAN), the Internet, or a combination thereof. The network 204 connects user devices 206, websites 208, advertisers 210, and the advertisement management system 202. The environment 200 may include many thousands of user devices 206, websites 208, and advertisers 210.

A website 208 is one or more resources 212 associated with a domain name and hosted by one or more servers. An example website is a collection of web pages formatted in hypertext markup language (HTML) that can contain text, images, multimedia content, and programming elements, such as scripts. Each website 208 is maintained by a publisher, which is an entity that controls, manages and/or owns the website 204.

A resource 212 is any data that can be provided over the network 204. A resource 212 is identified by a resource address that is associated with the resource 212. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as JavaScript scripts).

A user device 206 is an electronic device that is under control of a user and is capable of requesting and receiving resources over the network 204. Example user devices 206 include personal computers, mobile communication devices, embedded systems, same consoles and other devices that can send and receive data over the network 204. A user device 206 typically includes a user application, such as a web browser, to facilitate the sending and receiving of data over the network 204.

A user device 206 can request resources 212 from a website 208. In turn, data representing the resource 212 can be provided to the user device 206 for presentation by the user device 206. The data representing the resource 212 can also include data specifying a portion of the resource or a portion of a user display (e.g., a presentation location of a pop-up window or in a slot of a web page) in which advertisements can be presented. These specified portions of the resource or user display are referred to as advertisement slots.

To facilitate searching of these resources, the environment can include a search system 214 that identifies the resources by crawling and indexing the resources provided by the publishers on the websites 208. Data about the resources can be indexed based on the resource to which the data corresponds. The indexed and, optionally, cached copies of the resources are stored in an indexed cache 216.

User devices 206 can submit search queries 220 to the search system 214 over the network 204. In response, the search system 214 accesses the indexed cache 216 to identify resources that are relevant to the search query 220. The search system 214 identifies the resources in the form of search results 218 and returns the search results 218 to the user devices 206 in search results pages. A search result 218 is data generated by the search system 214 that identifies a resource that is responsive to a particular search query, and includes a link to the resource. An example search result 218 can include a web page title, a snippet of text or a portion of an image extracted from the web page, and the URL of the web page. Search results pages can also include one or more advertisement slots in which advertisements can be presented.

When a resource 212 or search results 218 are requested by a user device 206, the advertisement management system 202 receives a request for advertisements to be provided with the resource 212 or search results 218. The request for advertisements can include characteristics of the advertisement slots that are defined for the requested resource or search results page, and can be provided to the advertisement management system 202.

For example, a reference (e.g., URL) to the resource for which the advertisement slot is defined, a size of the advertisement slot, and/or media types that are available for presentation in the advertisement slot can be provided to the advertisement management system 202. Similarly, keywords associated with a requested resource (“resource keywords”) or a search query 220 for which search results are requested can also be provided to the advertisement management system 202 to facilitate identification of advertisements that are relevant to the resource or search query 220.

Based on data included in the request for advertisements, the advertisement system 202 can select advertisements that are eligible to be provided in response to the request (“eligible advertisements”). For example, eligible advertisements can include advertisements having characteristics matching the characteristics of advertisement slots and that are identified as relevant to specified resource keywords or search queries 220. In some implementations, advertisements having targeting keywords that match the resource keywords or the search query 200 are selected as eligible advertisements by the advertisement system 202.

A targeting keyword can match a resource keyword or a search query 220 by having the same textual content (“text”) as the resource keyword or search query 220. For example, an advertisement associated with the targeting keyword “daisy” can be an eligible advertisement for an advertisement request including the resource keyword “daisy.” Similarly, the advertisement can be selected as an eligible advertisement for an advertisement request including the search query “daisy.”

A targeting keyword can also match a resource keyword or a search query 220 by having text that is identified as being relevant to a targeting keyword or search query 220 despite having different text than the targeting keyword. For example, an advertisement having the targeting keyword “daisy” may also be selected as an eligible advertisement for an advertisement request including a resource keyword or search query for “flowers” because daisy is a type of flower, and therefore, is likely to be relevant to the term “flowers.”

Advertisement system 202 can select the eligible advertisements that are provided for presentation in advertisement slots of a resource or search results page based on results of an auction. For example, advertisement system 202 can receive bids from advertisers and allocate the advertisement slots to the highest bidders at the conclusion of the auction. The bids are amounts that the advertisers are willing to pay for presentation (or selection) of their advertisement with a resource or search results page.

For example, a bid can specify an amount an advertiser is willing to pay for a specified display time amount of the advertisement, referred to as a CPDT bid. The time period associated with the CPDT can be set by the advertiser or a publisher. Alternatively, a bid can specify an amount that an advertiser is willing to pay for each 1000 impressions (i.e., presentations) of the advertisement, referred to as a CPM bid. Alternatively, the bid can specify an amount that the advertiser is willing to pay for a selection (i.e., a click-through) of the advertisement or a “conversion” following selection of the advertisement. The highest bidders can be determined based on the bids alone, or based on the bids of each bidder being multiplied by one or more factors, such as quality scores derived from advertisement performance, landing page scores, and the like.

Advertisers can also specify budgets for their advertisement campaigns. A budget is a specified amount that an advertiser is willing to pay for distribution of content over a specified budget period. The specified period can be, for example, a specified time (e.g., one day, one week, or one year), a specified number of events (e.g., a number of impressions or clicks), or some other delineation of time or events. Once the amount the advertiser is charged for distribution of content during the budget period matches or exceeds the budget amount, the campaign can be prevented from providing content for the remainder of the budget period unless the advertiser increases or overrides its specified budget.

A conversion occurs when a user performs a particular action related to an advertisement provided with a resource or search results page. What constitutes a conversion may vary from case to case and can be determined in a variety of ways. For example, a conversion may occur when a user clicks on an advertisement, is referred to a web page, and consummates a purchase there before leaving that web page. A conversion can also be defined by an advertiser to be any measurable/observable user action such as, for example, downloading a white paper, navigating to at least a given depth of a website, viewing at least a certain number of web pages, spending at least a predetermined amount of time on a website or web page, or registering on a website. Other actions that constitute a conversion can also be used.

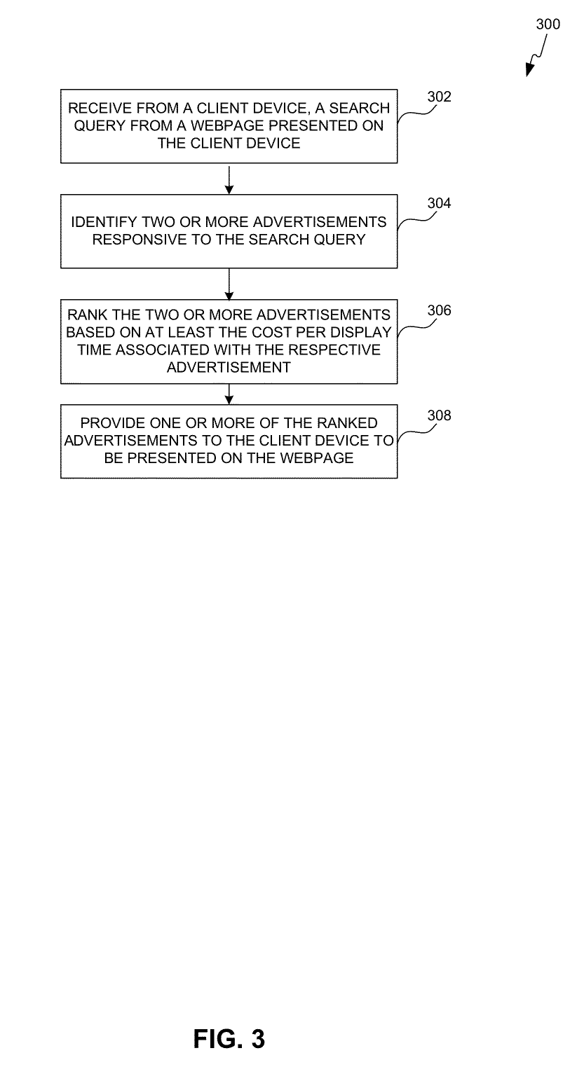

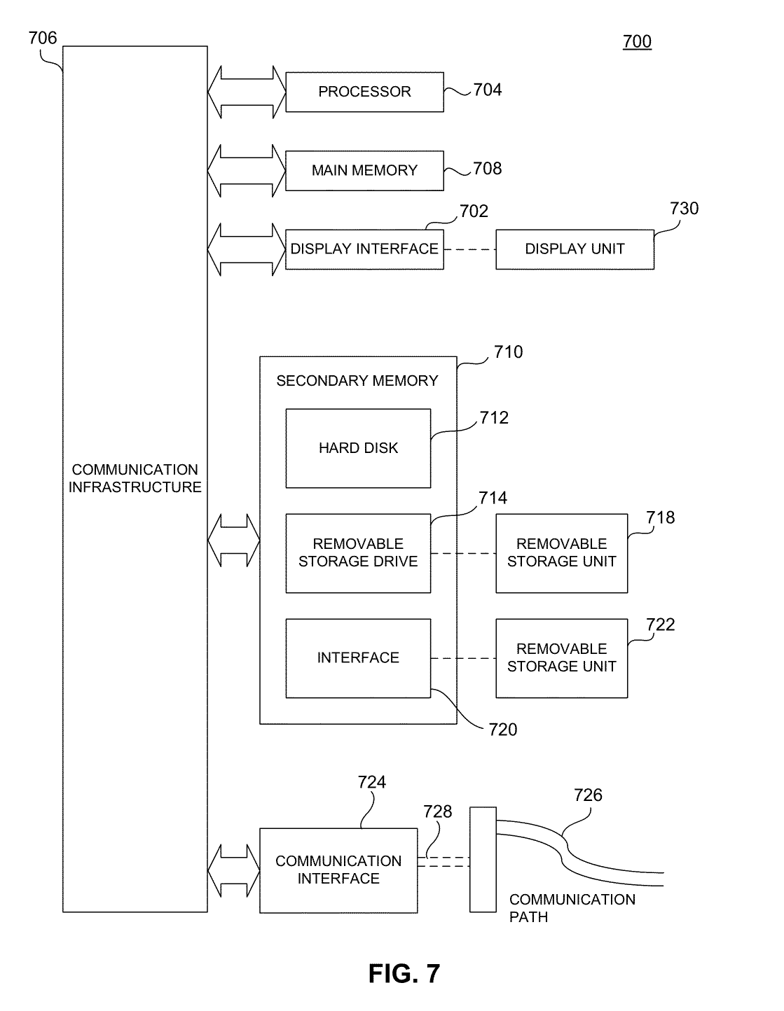

Advertisements are then provided to be presented on search results web pages or publisher webpages, and the advertiser is charged an amount based on the bidding model. An example process of charging advertisements based on a CPDT model is described with reference to FIG. 3-6. A system that can be used to implement these examples is then described with reference to FIG. 7.

FIG. 3 is a flowchart illustrating a method 300 for providing advertisements associated with a cost-per-display-time, according to an embodiment (steps 302-308).

In step 302, a search query is received from a webpage presented on a client device. The search query can be received from a search engine webpage or from a publisher's webpage.

In step 304, two or more advertisements are identified that are responsive to the search query. The advertisement can be associated with keywords that match the search query or that are closely related to the search query. Each advertisement associated with one or more keywords and a CPDT selected by a respective advertiser associated with the advertisement.

In some cases, the CPDT is one of a cost per second, a cost per minute, a cost per five minutes, a cost per ten minutes, a cost per hour, or a cost per day. In some cases, the time period associated with the CPDT is selected by the advertisement engine 104 and an advertiser can indicate whether they want to provide an advertisement to be associated with the specified time period. For example, an advertisement engine 104 can indicate that all advertisement have to be associated with a CPDT that is per minute.

In some cases, other factors are used as well to select the advertisements in addition to the CPDT. For example, the quality score of the advertisements can also be taken into account when selecting relevant advertisements.

In step 306, the two or more advertisements are ranked based on at least the cost-per-display-time associated with the respective advertisement. The advertisements can be ranked, for example, according to a decreasing CPDT amount. For example, Ad8 of FIG. 1C is associated with a CPDT of $0.08 would be ranked first and Ad6 is associated with a CPDT of $0.04 and would be ranked second if these two advertisements were the only ones responsive to a request for advertisements. In some cases, other features are used in the ranking as well, for example, the quality scores as described above.

In some cases, the CPDT of the advertisements in the ranking can be adjusted based on the CPDT of the advertisement below the current advertisement. For example, if an Ad8 is ranked first and associated with a CPDT of $0.08 and an Ad6 is ranked second and associated with a CPDT of $0.04. The CPDT of Ad8 can be adjusted so that the advertiser associated with Ad8 only has to pay the minimum CPDT that allows Ad8 to still hold the first position. Therefore, the CPDT of Ad8 can be adjusted to be a penny more than the CPDT of Ad6. The advertiser associated with Ad8 therefore only has to pay $0.05, one penny more than the CPDT of Ad6, and does not have to pay $0.08.

In step 308, one or more of the ranked advertisements are provided to the client device to be presented on the webpage. In some cases, if the advertisements are provided to a search result webpage, the advertisements are displayed with search results responsive to the search query used to select the advertisements. In other cases, the advertisements are displayed on a third-party publisher's webpage.

In one embodiment, an indication of an amount of time the advertisements were displayed on the webpage can be received by the advertisement engine 104. The advertisement engine 104 can calculate an advertisement charge as a function of the CPDT and the amount of time and the advertise can be charged this charge amount. The charge amount can then be deducted from the campaign budget of the advertiser.

According to an embodiment, steps 302, 304, 306, and 308 may be performed by a advertisement module 222 and an identification module 224. In other embodiments, steps 302, 304, 306, and 308 may be performed by a single module, for example, the advertisement module 222.

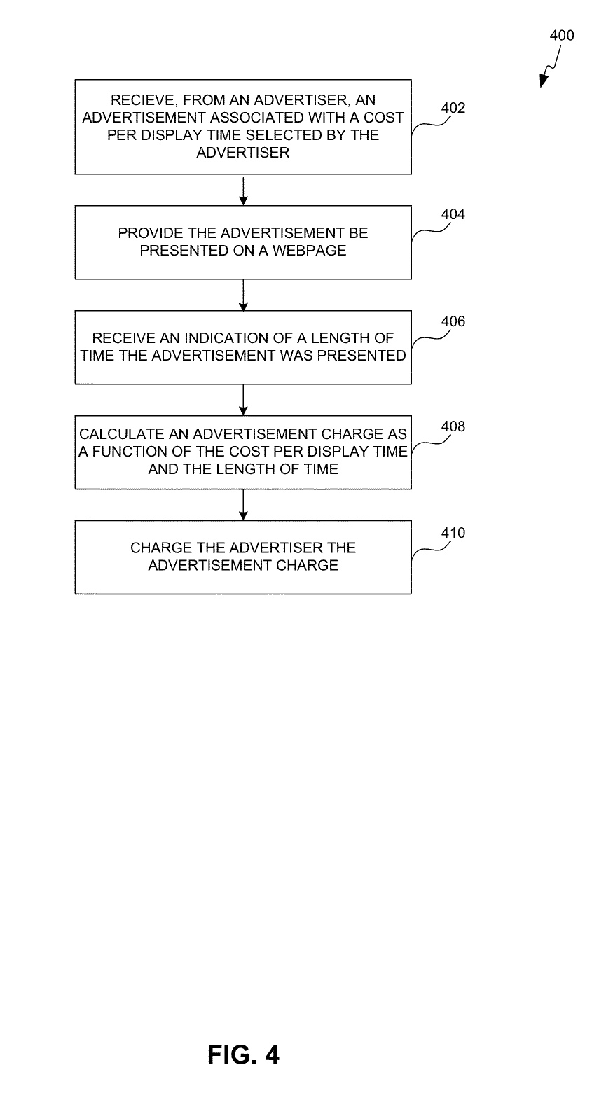

FIG. 4 illustrates an exemplary method 400 for an advertisement system based on a cost-per-display-time model, according to an embodiment.

In step 402, an advertisement associated with a cost-per-display-time selected by an advertiser is received from the advertiser. The CPDT is an amount the advertiser is charged for presentation of the advertisement.

In step 404, the advertisement is provided to be presented on a webpage. The advertisement can be identified based on a search query received from the webpage in the case of a search engine webpage. For example, the search query can be received from the webpage and a determination is made that the keyword associated with eth advertisement the advertiser provided is responsive to the search query. The advertisement can be presented along with search results that are responsive to the search query.

In step 406, an indication of a length of time the advertisement was presented on the webpage is received by the advertisement engine 104. A timer can embedded into the webpage that calculates the amount of time the advertisement is displayed. The indication can be received once the webpage is no longer presented on a browser, for example, when a user closes the browser or when a user navigates to another webpage. The indication can also be received once the entire advertisement is no longer presented on a browser displaying the webpage. For example, the user can scroll the webpage up or down and the advertisement displayed can be partially blocked. At this point, the timer stops, and the indication may be sent to the advertisement engine 104.

The indication can also be received by the advertisement engine 104 once a portion of the advertisement is no longer presented on a browser displaying the webpage. For example, if a user scrolls on the webpage and half of the advertisement is hidden from view, the indication can be sent to the advertisement engine 104. The indication can also be received once a scrolling event is received from a browser displaying the webpage. For example, if a user scrolls through the webpage on which the advertisement is displayed, the timer stops and the indication is sent to the advertisement engine 104. The indication can also be received the indication is received once an idle event is received from a browser displaying the webpage. For example, a user can stop viewing a webpage altogether and once the webpage is idle for a predetermined amount of time, the indication can be sent by the browser and received by the advertisement engine 104.

In step 408, an advertisement charge is calculated as a function of the CPDT and the length of time. For example, if the CPDT is $0.06 a minute and the advertisement was displayed for 5 minutes, the advertiser may be charged $0.30 for the presentation of the advertisement in step 410.

According to an embodiment, steps 402, 404, 406, and 408 may be performed by an advertisement module 222 and an identification module 224. In other embodiments, steps 402, 404, 406, and 408 may be performed by a single module, for example, the advertisement module 222.

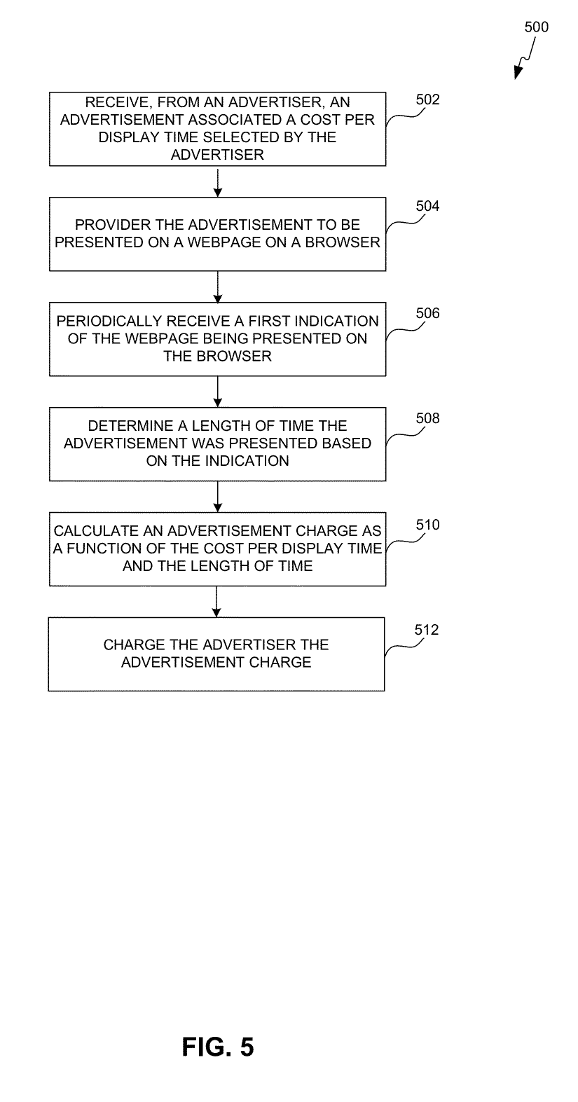

FIG. 5 is a flowchart illustrating a method 500 for charging advertisers for advertisements associated with a cost-per-display-time, according to an embodiment (steps 502-512).

In step 502, an advertisement associated a CPDT selected by an advertiser is received from the advertiser. The CPDT is an amount the advertiser is charged for presentation of the advertisement per the specified time period.

In step 504, the advertisement is provided to be presented on a webpage displayed on a browser. The webpage can be third-party publisher's webpage or a search results webpage.

In step 506, a first indication of the webpage being presented on the browser is periodically received from the browser. The indication can be received at a preset interval of time. For example, every five seconds if the advertisement is still displayed on the browser, the indication can be sent from the browser to the advertisement engine 104.

In step 508, the advertisement engine 104 can determine length of time the advertisement was presented based on the indication. For example, the advertisement engine 104 can determine the length of time based on the number of indications received. If six 5 second interval indications are received, the advertisement engine 104 determines that the advertisement was displayed for 30 seconds.

In step 510, an advertisement charge is calculated as a function of the CPDT and the length of time. For example, the charge can be the CPDT multiplied by the length of time the advertisement was displayed.

In step 512, the advertiser is charged the advertisement charge. In some cases, a campaign amount is received from the advertiser and if the campaign amount has not been depleted, the charge is deducted from the campaign amount. If the campaign amount has been depleted, a second indication can be sent to the browser to remove the advertisement from the webpage. Therefore, the advertisement is displayed until the campaign amount is depleted completely.

According to an embodiment, steps 502, 504, 506, 508, 510, and 512 may be performed by an advertisement module 222 and an identification module 224. In other embodiments, steps 502, 504, 506, 508, 510, and 512 may be performed by a single module, for example, the advertisement module 222.

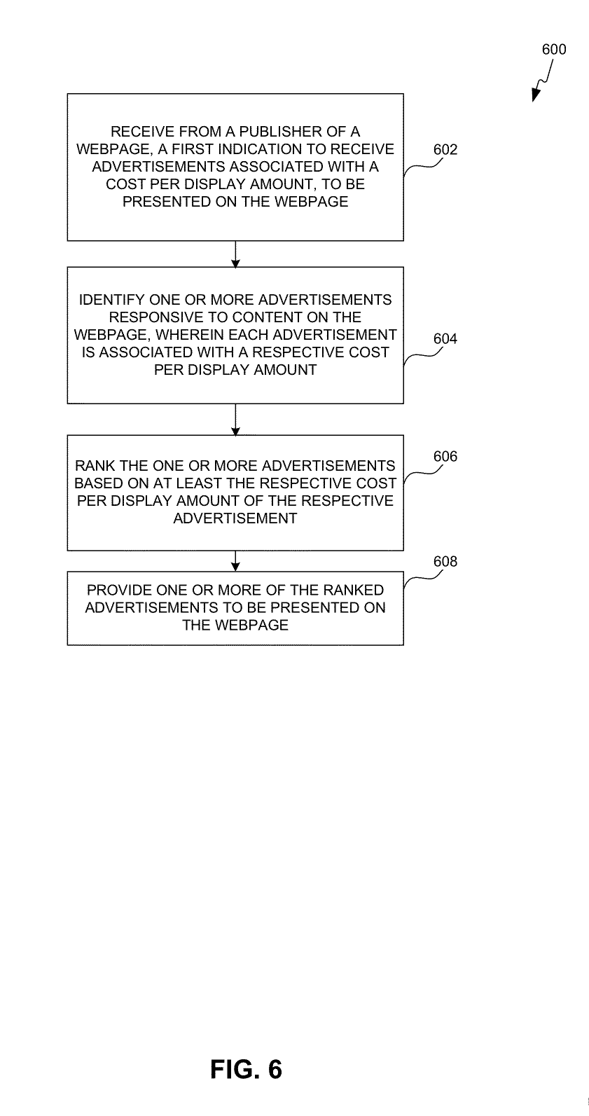

FIG. 6 is a flowchart illustrating a method 600 for providing advertisements associated with a cost-per-display-time, according to an embodiment (steps 602-608).

In step 602, a first indication to receive advertisements associated with a CPDT, is received from a publisher of a webpage, to be presented on the webpage of the publisher. For example, a publisher of a webpage may want to display advertisements on their webpage that are associated with a CPDT as opposed to a CPC model.

In some cases, the publisher can indicate a minimum CPDT that the advertisement must be associated with. For example, the publisher may only want to display advertisements that are associated with a CPDT of $0.02 or higher. In some cases, the publisher can indicate whether the advertisement are to be associated with a certain time period in the CPDT. For example, a publisher can indicate to only receive advertisement that are associated with a CPDT that includes a cost per second, or a cost per minute. In some cases, the CPDT of each advertisement is selected by the advertiser associated with the advertisement.

In step 604, one or more advertisements responsive to content on the webpage are identified, wherein each advertisement is associated with a respective CPDT. The advertisements can be associated with keywords that are responsive the content keywords of the webpage associated with the publisher. The advertisements can be associated with respective CPDTs that meet or exceed the minimum CPDT if one is indicated by the publisher.

In step 606, the one or more advertisements are ranked based on at least the respective CPDT of the respective advertisement. In some cases, the rank can be based on a function of the respective CPDT and a quality score associated with each respective advertisement.

In step 608, one or more of the ranked advertisements are provided to be presented on the webpage. In some cases, a second indication of an amount of time each of the one or more ranked advertisements were presented on the webpage is received. The second indication can be received from the browser that is displaying the webpage. The second indication can be received by the advertisement engine 104 and the system can calculate an advertisement charge as a function of the CPDT and the length of time specified in the indication.

In some cases, a timer on the browser determines the amount of time the advertisement was displayed. The advertiser is charged the advertisement charge. In some cases, as described above, the amount can be deducted from the campaign amount, if it has not been depleted.

According to an embodiment, steps 602, 604, 606, and 608 may be performed by an advertisement module 222 and an identification module 224. In other embodiments, steps 602, 604, 606, and 608 may be performed by a single module, for example, the advertisement module 222.

FIG. 7 illustrates an example computer system 700 in which embodiments of the present invention, or portions thereof, may by implemented as computer-readable code. For example, advertisement engine 104 or advertisement management system 202 (which can include the advertisement engine 104) may be implemented in computer system 700 using hardware, software, firmware, tangible computer readable media having instructions stored thereon, or a combination thereof and may be implemented in one or more computer systems or other processing systems. Hardware, firmware, software, or any combination of such may embody any of the modules and components in FIGS. 1-6.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above described embodiments. A processor device may be a single processor, a plurality of processors, or combinations thereof. Processor devices may have one or more processor “cores.”

Various embodiments of the invention are described in terms of this example computer system 700. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. As will be appreciated by persons skilled in the relevant art, processor device 704 may also be a single processor in a multi-core/multiprocessor system, such system operating alone, or in a cluster of computing devices operating in a cluster or server farm. Processor device 704 is connected to a communication infrastructure 706, for example, a bus, message queue, network, or multi-core message-passing scheme.

Computer system 700 also includes a main memory 708, for example, random access memory (RAM), and may also include a secondary memory 710. Secondary memory 710 may include, for example, a hard disk drive 712, removable storage drive 714. Removable storage drive 714 may comprise a floppy disk drive, a magnetic tape drive, an optical disk drive, a flash memory, or the like. The removable storage drive 714 reads from and/or writes to a removable storage unit 718 in a well known manner. Removable storage unit 718 may comprise a floppy disk, magnetic tape, optical disk, etc. which is read by and written to by removable storage drive 714. As will be appreciated by persons skilled in the relevant art, removable storage unit 718 includes a computer usable storage medium having stored therein computer software and/or data.

In alternative implementations, secondary memory 710 may include other similar means for allowing computer programs or other instructions to be loaded into computer system 700. Such means may include, for example, a removable storage unit 722 and an interface 720. Examples of such means may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to computer system 700.

Computer system 700 may also include a communications interface 724. Communications interface 724 allows software and data to be transferred between computer system 700 and external devices. Communications interface 724 may include a modem, a network interface (such as an Ethernet card), a communications port, a PCMCIA slot and card, or the like. Software and data transferred via communications interface 724 may be in the form of signals, which may be electronic, electromagnetic, optical, or other signals capable of being received by communications interface 724. These signals may be provided to communications interface 724 via a communications path 726. Communications path 726 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 718, removable storage unit 722, and a hard disk installed in hard disk drive 712. Computer program medium and computer usable medium may also refer to memories, such as main memory 708 and secondary memory 710, which may be memory semiconductors (e.g. DRAMs, etc.).

Computer programs (also called computer control logic) are stored in main memory 708 and/or secondary memory 710. Computer programs may also be received via communications interface 724. Such computer programs, when executed, enable computer system 700 to implement the present invention as discussed herein. In particular, the computer programs, when executed, enable processor device 704 to implement the processes of the present invention, such as the stages in the methods illustrated by flowcharts 300, 400, 500, and 600 of FIGS. 3, 4, 5, and 6, respectively, discussed above. Accordingly, such computer programs represent controllers of the computer system 700. Where an embodiment of invention is implemented using software, the software may be stored in a computer program product and loaded into computer system 700 using removable storage drive 714, interface 720, and hard disk drive 712, or communications interface 724.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer-implemented method, comprising:
receiving at a computing device, from a client device, a query from a webpage presented on the client device;
using the computing device to identify two or more advertisements responsive to the query, each advertisement associated with:
one or more keywords, and
a cost-per-display-time selected by a respective advertiser associated with the advertisement, wherein the cost-per-display-time is a cost per a unit of time for displaying the advertisement on the client device;
ranking the two or more advertisements based on at least the cost-per-display-time associated with the respective advertisement; and
providing one or more of the ranked advertisements to the client device to be presented on the webpage for display on the webpage on a user interface, the webpage having code embedded therein for defining a timer, the timer configured to determine a length of time the one or more ranked advertisements are displayed and fully viewable by a user on the user interface.

2. The method of claim 1, wherein the cost-per-display-time is one of a cost per second, a cost per minute, a cost per five minutes, a cost per ten minutes, or a cost per hour.

3. The method of claim 1, wherein the webpage is a publisher webpage or a search engine webpage.

4. The method of claim 1, further comprising:
adjusting the cost-per-display-time associated with each advertisement in the ranking based on the cost-per-display-time associated with the advertisement ranked below the respective advertisement.

5. The method of claim 1, wherein ranking the two or more advertisements based on at least the cost-per-display-time associated with the respective advertisement companies:
ranking the two or more advertisements based on the cost-per-display-time associated with the respective advertisement and a quality score associated with each advertisement.

6. The method of claim 1, wherein providing the one or more of the ranked advertisements to the client device to be presented on the webpage comprises:
providing one or more of the ranked advertisements to the client device to be presented on the webpage with search results responsive to the query.

7. The method of claim 1, further comprising:
receiving an indication of a length of time the advertisement was presented on the webpage wherein the indication is determined by a timer associated with the advertisement;
calculating an advertisement charge as a function of the cost-per-display-time and the indication of the length of time; and
charging the advertiser the advertisement charge.

8. A system, comprising:
an advertisement module, implemented on a computing device, configured to:
receive, from a client device, a query from a webpage presented on the client device;
identify two or more advertisements responsive to the query, each advertisement associated with:
one or more keywords, and
a cost-per-display-time selected by a respective advertiser associated with the advertisement, wherein the cost-per-display-time is a cost per a unit of time for displaying the advertisement on the client device;
rank the two or more advertisements based on at least the cost-per-display-time associated with the respective advertisement; and
provide one or more of the ranked advertisements to the client device to be presented on the webpage for display on the webpage on a user interface, the webpage having code embedded therein for defining a timer, the timer configured to determine a length of time the one or more ranked advertisements are displayed and fully viewable by a user on the user interface.

9. The system of claim 8, wherein the cost-per-display-time is one of a cost per second, a cost per minute, a cost per five minutes, a cost per ten minutes, or a cost per hour.

10. The system of claim 8, wherein the webpage is a publisher webpage or a search engine webpage.

11. The system of claim 8, wherein the advertisement module is further configured to:
adjust the cost-per-display-time based associated with each advertisement in the ranking based on the cost-per-display-time associated with the advertisement ranked below the respective advertisement.

12. The system of claim 8, wherein the advertisement module is further configured to:
rank the two or more advertisements based on the cost-per-display-time associated with the respective advertisement and a quality score associated with each advertisement.

13. The system of claim 8, wherein the advertisement module is further configured to:
provide one or more of the ranked advertisements to the client device to be presented on the webpage with search results responsive to the query.

14. The system of claim 8, wherein the advertisement module is further configured to:
receive an indication of a length of time the advertisement was presented on the webpage wherein the indication is determined by a timer associated with the advertisement;
calculate an advertisement charge as a function of the cost-per-display-time and the length of time; and
charge the advertiser the advertisement charge.

15. A non-transitory computer storage medium encoded with a computer program, the program comprising instructions that when executed by one or more processors cause the one or more processors to perform operations comprising:
receiving, from a client device, a query from a webpage presented on the client device;
identifying two or more advertisements responsive to the query, each advertisement associated with:
one or more keywords, and
a cost-per-display-time selected by a respective advertiser associated with the advertisement, wherein the cost-per-display-time is a cost per a unit of time for displaying the advertisement on the client device;
ranking the two or more advertisements based on at least the cost-per-display-time associated with the respective advertisement; and
providing one or more of the ranked advertisements to the client device to be presented on the webpage for display on the webpage on a user interface, the webpage having code embedded therein for defining a timer, the timer configured to determine a length of time the one or more ranked advertisements are displayed and fully viewable by a user on the user interface.

16. The computer storage medium of claim 15, wherein the cost-per-display-time is one of a cost per second, a cost per minute, a cost per five minutes, a cost per ten minutes, or a cost per hour.

17. The computer storage medium of claim 15, wherein the webpage is a publisher webpage or a search engine webpage.

18. The computer storage medium of claim 15, wherein the operations further comprise:
adjusting the cost-per-display-time associated with each advertisement in the ranking based on the cost-per-display-time associated with the advertisement ranked below the respective advertisement.

19. The computer storage medium of claim 15, wherein the operations further comprise:
ranking the two or more advertisements based on the cost-per-display-time associated with the respective advertisement and a quality score associated with each advertisement.

20. The computer-implemented method of claim 1, further comprising:
receiving an indication of a length of time the one or more ranked advertisements was presented on the webpage after the one or more ranked advertisements is partially blocked from display;
calculating an advertisement charge as a function of the cost-per-display-time and the indication of the length of time; and
charging the advertiser the advertisement charge.

21. The system of claim 8, wherein the advertisement module is further configured to:
receiving an indication of a length of time the one or more ranked advertisements was presented on the webpage after the one or more ranked advertisements is partially blocked from display;
calculating an advertisement charge as a function of the cost-per-display-time and the indication of the length of time; and
charging the advertiser the advertisement charge.

22. The computer storage medium of claim 15, wherein the operations further comprise:
calculating an advertisement charge as a function of the cost-per-display-time and the indication of the length of time; and
charging the advertiser the advertisement charge.
